(19) United States
(12) Patent Application Publication
(10) Pub. No.: US 2015/0085273 A1
(43) Pub. Date: Mar. 26, 2015

(54) MEASUREMENT SUPPORT DEVICE, MEASUREMENT SUPPORTING METHOD, AND COMPUTER PROGRAM PRODUCT

(71) Applicant: KABUSHIKI KAISHA TOSHIBA, Tokyo (JP)

(72) Inventors: Yuta Itoh, Kawasaki (JP); Akihito Seki, Yokohama (JP); Satoshi Ito, Kawasaki (JP); Masaki Yamazaki, Tokyo (JP); Hideaki Uchiyama, Kawasaki (JP)

(21) Appl. No.: 14/481,979

(22) Filed: Sep. 10, 2014

(30) Foreign Application Priority Data
Sep. 20, 2013 (JP) 2013-195736

(51) Int. Cl. G01C 3/08

(52) U.S. Cl. CPC G01C 3/08
USPC 356/4.01

(57) ABSTRACT

According to an embodiment, a first calculator, a second calculator, a determination unit, and an informing controller. The first calculator is configured to calculate a projection position on which the point is projected on each image obtained by an image-capturing unit, by using a direction, a first distance from a measurement unit to an irradiated point of an object, and calibration information between both units. The second calculator is configured to calculate a set of reprojection positions by reprojecting a three-dimensional position on each image. The determination unit is configured to extract, from the set, a reprojection position on an image containing the projection position calculated from the point measured and captured within a certain time period, and calculate a second distance between the reprojection and projection positions. The informing controller is configured to prompt to irradiate the object in a direction in which the second distance decreases.

### CROSS-REFERENCE TO RELATED APPLICATION

This application is based upon and claims the benefit of priority from Japanese Patent Application No. 2013-195736, filed on Sep. 20, 2013; the entire contents of which are incorporated herein by reference.

### FIELD

An embodiment described herein relates generally to a measurement support device, a measurement supporting method, and a computer program product.

### BACKGROUND

A measurement device that includes an image-capturing unit such as a camera and a measurement unit such as a laser range finder (LRF) calculates (produces) a three-dimensional model of an object by using a position of the object obtained from an image captured by the image-capturing unit, a distance to the object measured by the measurement unit, and calibration information obtained by calibrating the measurement unit and the image-capturing unit.

In the measurement device described above, the measurement unit needs to accurately measure the distance to the position of the object obtained from the image captured by the image-capturing unit in order to calculate an accurate three-dimensional model of the object. It is difficult, however, for the measurement unit to irradiate the exact position with laser. This may cause a difference between the actual distance and the measured distance to the position, thereby causing degradation in accuracy.

A conventional technology is known in which the image-capturing unit captures an image containing the measurement unit, the object, and an irradiated point of laser on the object emitted by the measurement unit, and the measurement device corrects the three-dimensional model (position coordinates of the three-dimensional model) of the object so that the objective function of the distance measured by the measurement unit and the distance between the image-capturing unit and the irradiated point in the image is minimized.

### BRIEF DESCRIPTION OF THE DRAWINGS

FIG. 1 is a configuration diagram illustrating an example of a measurement support device according to an embodiment;

FIG. 2 is a diagram illustrating an example of observation by a measurement unit and an image-capturing unit according to the embodiment;

FIG. 3 is a diagram illustrating an example of a method for dividing an image into regions according to the embodiment;

FIG. 4 is a diagram illustrating an example of an informing operation according to the embodiment;

FIG. 5 is a flowchart illustrating an example of processing performed by the measurement support device according to the embodiment; and

FIG. 6 is a block diagram illustrating an example of a hardware configuration of the measurement support device according to the embodiment.

### DETAILED DESCRIPTION

According to an embodiment, a measurement support device includes a measurement unit, an image-capturing unit, a first calculator, a second calculator, a determination unit, and an informing controller. The measurement unit is configured to sequentially irradiate an object with a light beam and sequentially measure a direction and a first distance to an irradiated point on the object. The image-capturing unit is configured to sequentially capture images of the object irradiated with the light beam. The first calculator is configured to calculate, when the direction and the first distance to the irradiated point are measured, a projection position on which the irradiated point is projected on each of the images by using the direction, the first distance, and calibration information that is based on calibration performed in advance between the measurement unit and the image-capturing unit. The second calculator is configured to calculate a set of reprojection positions by reprojecting, on each of the images, a three-dimensional position that is based on each of the images sequentially captured. The determination unit is configured to extract, from the set of reprojection positions, a reprojection position on an image containing the projection position calculated from the irradiated point that is measured and captured within a certain time period, calculate a second distance between the reprojection position and the projection position, and determine to which category the second distance belongs. The informing controller is configured to cause, when the determined category indicates continuation of measurement, an informing unit to inform of informing information that prompts to direct the measurement unit to irradiate the object with the light beam in a direction in which the second distance decreases.

An embodiment will be described in detail with reference to the accompanying drawings.

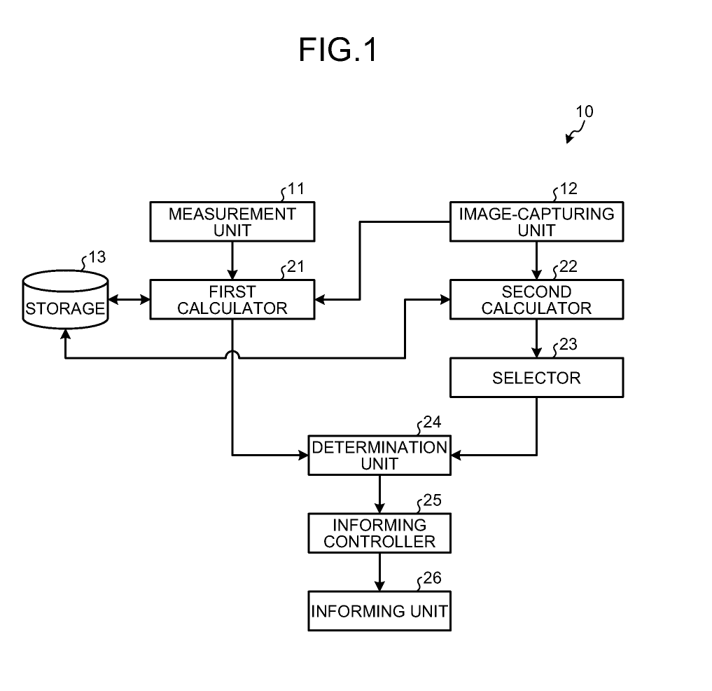

FIG. 1 is a configuration diagram illustrating an example of a measurement support device 10 according to the embodiment. As illustrated in FIG. 1, the measurement support device 10 includes a measurement unit 11, an image-capturing unit 12, a storage 13, a first calculator 21, a second calculator 22, a selector 23, a determination unit 24, an informing controller 25, and an informing unit 26.

The measurement unit 11 can be implemented by a measurement device such as a LRF. Although the embodiment describes a case in which the measurement unit 11 is a LRF, the embodiment is not limited to this. The measurement unit 11 may be a device, such as a time-of-flight (ToF) camera using the phase shift method, that can acquire three-dimensional coordinates of an object. ToF is a method for measuring a distance from a time period required for a round-trip of laser emitted by the measurement unit to and from the object. The image-capturing unit 12 can be implemented by an image-capturing device such as an optical camera.

The storage 13 can be implemented by a storage device that can store therein data magnetically, optically, or electrically such as a hard disk drive (HDD), a solid state drive (SSD), a memory card, an optical disc, or a random access memory (RAM).

The first calculator 21, the second calculator 22, the selector 23, the determination unit 24, and the informing controller 25 can be implemented by causing a processor such as a central processing unit (CPU) to execute computer programs, that is, implemented by software. The informing unit 26 can be implemented by at least one of a display device such as a display, an audio output device such as a speaker, or a light-emitting device such as a lamp or a light-emitting diode (LED).

The measurement unit 11 sequentially irradiates an object with a light beam to sequentially measure a direction and a distance (a first distance) to an irradiated point on the object. The irradiated point is a position on the object on which the emitted light beam hits.

The measurement unit 11 may irradiate the object with a plurality of light beams at once. In this case, the measurement unit 11 irradiates the object with the light beams and measures directions and distances to the irradiated points on the object for the respective light beams.

The image-capturing unit 12 sequentially captures images of the object irradiated with a light beam by the measurement unit 11. The image-capturing unit 12, for example, captures visible light in space containing the object to obtain an image in which brightness of the object is recorded.

It is assumed that the measurement unit 11 and the image-capturing unit 12 are disposed in a fixed position so that an irradiated region with a light beam emitted by the measurement unit 11 and an image-capturing region of the image-capturing unit 12 overlap with each other. It is also assumed that the image-capturing unit 12 captures images of the object with the measurement unit 11 irradiating the object with a light beam.

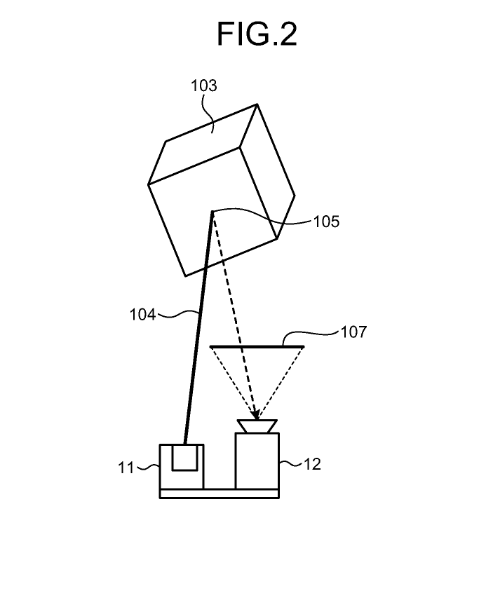

FIG. 2 is a diagram illustrating an example of observation by the measurement unit 11 and the image-capturing unit 12 according to the present embodiment. As illustrated in FIG. 2, the measurement unit 11 irradiates an object 103 with a light beam 104, and measures reflected light of the light beam 104 reflected on an irradiated point 105 to measure a direction and a distance to the irradiated point 105. The image-capturing unit 12 captures an image 107 on which the object 103 is captured, and stores brightness of a captured subject such as the object 103 in the image 107.

The measurement unit 11 and the image-capturing unit 12 may observe an object separately for a plurality of time periods, or may observe the object simultaneously for the time periods. Observing an object separately means that the measurement unit 11 and the image-capturing unit 12 are not synchronized with each other in observation, and observing an object simultaneously means that the measurement unit 11 and the image-capturing unit 12 are synchronized with each other in observation.

The storage 13 stores therein calibration information based on calibration performed in advance between the measurement unit 11 and the image-capturing unit 12. The calibration information indicates at least one of the relative position and orientation of the measurement unit 11 and the image-capturing unit 12. Examples of the calibration information include a geometric transformation parameter (Rrc, Trc) obtained by rotation and translation from a measurement coordinate system Or defined by the optical center and the direction of the optical axis of the measurement unit 11 to an image-capturing coordinate system Oc defined by the optical center and the direction of the optical axis of the image-capturing unit 12.

When the measurement unit 11 measures a direction and a distance to an irradiated point, the first calculator 21 calculates a projection position on which the irradiated point is projected on an image by using the measured direction and distance and the calibration information stored in the storage 13. The projection position may be hereinafter referred to as a projection point.

For example, the first calculator 21 calculates a projection point x on an image captured by the image-capturing unit 12 by using a three-dimensional position Xr of an irradiated point in the measurement coordinate system Or, calibration information (Rrc, Trc), a coefficient of a distortion model of the image-capturing unit 12, and a projection function.

The three-dimensional position Xr is determined by the direction and the distance to the irradiated point measured by the measurement unit 11. The coefficient of the distortion model is known by the image-capturing unit 12. Examples of the coefficient of the distortion model include an intrinsic parameter matrix K and a lens distortion function that represent a focal length and the image center. Although, in the present embodiment, a distortion model represented by five parameters including three parameters of radial distortion and two parameters of tangential distortion is used as the lens distortion function, the embodiment is not limited to this. A more complex distortion model may be used in accordance with the lens model of the image-capturing unit 12. The projection function can be defined by using, for example, the expression (16) described in Weng, J. and Cohen, P. and Herniou, M., “Camera calibration with distortion models and accuracy evaluation,” IEEE Transactions on pattern analysis and machine intelligence, volume 14, number 10, 1992, pp. 965-980.

When the measurement unit 11 irradiates the object with a plurality of light beams at once, the first calculator 21 calculates a plurality of projection positions on which a plurality of irradiated points are projected on an image.

The second calculator 22 reprojects a three-dimensional position based on each of the images sequentially captured by the image-capturing unit 12 on each of the images to calculate a set of reprojection positions. The reprojection position may be hereinafter referred to as a reprojection point.

The second calculator 22, for example, uses simultaneous localization and mapping (SLAM) to calculate, from two or more time-series images captured by the image-capturing unit 12, a viewpoint position and a view direction of the image-capturing unit 12, and a three-dimensional position X_T observed at the time at which the image-capturing unit 12 captures each image. The second calculator 22 reprojects the three-dimensional position X_T on each of the images captured by the image-capturing unit 12 in the same manner as performed by the first calculator 21. The second calculator 22 calculates a reprojection point on each image to calculate a set T of reprojection points. The second calculator 22 may exclude a reprojection point located outside of an image from the set T of reprojection points. “A reprojection point located outside of an image” means that the reprojection point is not captured in a subject image. This occurs when the three-dimensional position X_T is calculated by using a plurality of images and when the three-dimensional position X_T is captured in some images and is not captured in the other images.

When the image-capturing unit 12 captures a new image, the second calculator 22 recalculates (updates) the three-dimensional position X_T by using the new image in addition to the images already captured by the image-capturing unit 12. The second calculator 22 reprojects the three-dimensional position X_T on each of the images captured by the image-capturing unit 12, calculates a reprojection point on each of the images, and updates the set T of reprojection points. Such a recursive method for updating the set T of reprojection points is disclosed, for example, in B. D. Lucas and T. Kanade, “An Iterative Image Registration Technique with an Application to Stereo Vision,” in Proc. of Int. Joint Conf. on Artificial Intelligence, pp. 674-679, August 1981.

As described above, the three-dimensional position X_T and the set T of reprojection points change in value as time proceeds. When the second calculator 22 performs processing by using the three-dimensional position X_T or the set T of reprojection points, the second calculator 22 uses the latest three-dimensional position X_T or the latest set T of reprojection points. The method for updating the three-dimensional position X_T and the set T of reprojection points, however, is not limited to this. The second calculator 22 may associate a past three-dimensional position X_T with a past set T of reprojection points and store them in, for example, the storage 13 when updating the three-dimensional position X_T and the set T of reprojection points. This enables the second calculator 22 to perform processing by using the past three-dimensional position X_T and the past set T of reprojection points.

When the second calculator 22 calculates a plurality of three-dimensional positions X_T, the second calculator 22 reprojects the three-dimensional positions X_T on each image to calculate a plurality of sets T of reprojection positions.

The selector 23 selects, from a plurality of sets T of reprojection positions, candidate positions that are reprojection positions obtained by reprojecting three-dimensional positions with higher measurement accuracy to acquire a set TC of candidate positions. A candidate position may be hereinafter referred to as a candidate point. A three-dimensional position with higher measurement accuracy is, for example, a three-dimensional position measured by the image-capturing unit 12 or a three-dimensional position measured by the measurement unit 11 that has higher measurement accuracy than a certain value.

The selector 23 defines, as Length_num (T, t), the number of reprojection points in a set T of reprojection points from the most previous time to time t, and defines, as Length_time (T, t), a time period from the most previous time to time t in the set T of reprojection points.

The selector 23 estimates, from an image captured at time t, a specular reflection rate Ref_rate (X_T, t) and a diffuse reflection rate Dif_rate (X_T, t) of the three-dimensional position X_T. To estimate the specular reflection rate Ref_rate (X_T, t) and the diffuse reflection rate Dif_rate (X_T, t), the selector 23 can employ a method disclosed, for example, in Tomoaki Higo, Daisuke Miyazaki, Katsushi Ikeuchi, “Realtime Removal of Specular Reflection Component Based on Dichromatic Reflection Model (General Session 5),” Information Processing Society of Japan, Computer Vision and Image Media (CVIM), Volume 93, 2006, pp. 211-218, Sep. 8, 2006.

The selector 23 uses a viewpoint position (calculated by SLAM) of the image-capturing unit 12 at time t to calculate a relative distance Rel_dis (X_T, t) (a third distance) from the image-capturing unit 12 to the three-dimensional point X_T at time t. The three-dimensional point X_T and the viewpoint position and the view direction of the image-capturing unit 12 at time t are represented in a coordinate system with the origin being at the position of the image-capturing unit 12 at image-capturing time of an image on which SLAM was started. The coordinate system is represented in an uncertain reduction scale. An image on which SLAM is started is, for example, an image first given when the set T of reprojection points is calculated.

The selector 23 calculates a prediction error Rel_err (X_T, t) in the relative distance Rel_dis (X_T, t) of the image-capturing unit 12 relative to the object by using two sets of a viewpoint position and a view direction of the image-capturing unit 12, the pixel size of optical elements in the image-capturing unit 12, and an intrinsic parameter of the image-capturing unit 12. To calculate the prediction error Rel_err (X_T, t), the selector 23 may employ a method disclosed, for example, in J. J. Rodriguez and J. K. Aggarwal, “Stochastic analysis of stereo quantization error,” IEEE Transactions on Pattern Analysis and Machine Intelligence, 12:467-470, 1990. For example, the selector 23 may use, as the two sets of a viewpoint position and a view direction of the image-capturing unit 12, viewpoint positions and view directions of the image-capturing unit 12 at the most previous time in the elements of the set T of reprojection points and at time t.

From sets of three-dimensional points {X_Tj} corresponding to a plurality of sets of reprojection positions {Tj} (j=1, 2, . . . , M) calculated by the second calculator 22, the selector 23 selects, as candidate points, {Tj} corresponding to {X_Tj} satisfying, for example, the following conditions: Length_num (T, t) is larger than a certain value α1, Length_time (T, t) is larger than a certain value α2, Ref_rate (X_T, t) is smaller than a certain value α3, Dif_rate (X_T, t) is larger than a certain value α4, Rel_dis (X_Tj, t) is smaller than a certain value β1 and is the minimum, and Rel_err (X_Tj, t) is smaller than a certain value β2 and is the minimum. The selector 23 thus acquires a set TC of candidate points.

Specifically, the selector 23 sets a measurement recommendation flag G of {Tj} corresponding to {X_Tj} that satisfies the above-described conditions to 1, and sets the measurement recommendation flag G of {Tj} corresponding to {X_Tj} that does not satisfy the above-described conditions to 0, thereby acquiring the set TC of candidate points. The measurement recommendation flag G is a flag indicating whether a candidate point (reprojection point) is suitable for measurement. When the measurement recommendation flag G is 1, the candidate point is suitable for measurement. When it is 0, the candidate point is not suitable for measurement. The initial value of the measurement recommendation flag G is 0. The value of the measurement recommendation flag G is inherited even when the set T of reprojection points is updated by the second calculator 22 and when the set TC of candidate points is updated.

Although, in the present embodiment, it is assumed to select a reprojection point that satisfies all the conditions described above as a candidate point, the embodiment is not limited to this. A reprojection point that satisfies at least one of the conditions may be selected as a candidate point. Although the above-described conditions specify that Rel_dis (X_Tj, t) and Rel_err (X_Tj, t) are the minimum, the embodiment is not limited to this. The conditions may specify that Rel_dis (X_Tj, t) and Rel_err (X_Tj, t) are among the first certain number of values when sorted in ascending order.

The determination unit 24 extracts, from the set of reprojection positions calculated by the second calculator 22, a reprojection position on an image containing a projection position calculated from an irradiated point measured and captured within a certain time period. The determination unit 24 calculates a distance (a second distance) between the reprojection position and the projection position and determines to which category the distance belongs.

When the second calculator 22 calculates a plurality of sets T of reprojection positions, the determination unit 24 extracts, from the sets T of reprojection positions, a plurality of reprojection positions on an image containing a projection position calculated from an irradiated point measured and captured within a certain time period. The determination unit 24 calculates the minimum distance among distances between the reprojection positions and the projection position and determines to which category the minimum distance belongs.

The determination unit 24 may extract, from the sets T of reprojection positions, one or more reprojection positions contained in a region containing a larger number of reprojection positions among the reprojection positions on an image containing a projection position calculated from an irradiated point measured and captured within a certain time period.

In practice, the determination unit 24 extracts, from the set TC of candidate positions selected by the selector 23, a candidate position on an image containing a projection position calculated from an irradiated point measured and captured within a certain time period. The determination unit 24 then calculates a distance between the candidate position and the projection position.

When the measurement unit 11 irradiates the object with a plurality of light beams, the determination unit 24 extracts, from a set T of reprojection positions, a reprojection position on an image containing a plurality of projection positions calculated from a plurality of irradiated points measured and captured within a certain time period. The determination unit 24 calculates the minimum distance among distances between the projection positions and the reprojection position and determines to which category the minimum distance belongs.

It is assumed, in the present embodiment, that “measured and captured within a certain time period” means that measuring time and image-capturing time coincide with each other, but the embodiment is not limited to this. Some errors may be tolerable between the measuring time and the image-capturing time.

When the calculated distance is larger than a threshold, the determination unit 24 determines that the distance belongs to a category indicating continuation of measurement. When the calculated distance is equal to or smaller than the threshold, the determination unit 24 determines that the distance belongs to a category indicating completion of measurement.

The following describes detailed processing performed by the determination unit 24.

First, the determination unit 24 extracts a set Cand of candidate points at time t from a set TC of candidate points selected by the selector 23. The determination unit 24 divides an image at time t into a plurality of regions, counts the number of candidate points belonging to the set Cand in each region, and uses a candidate point belonging to a region that contains the largest number of candidate points to determine a measurement situation.

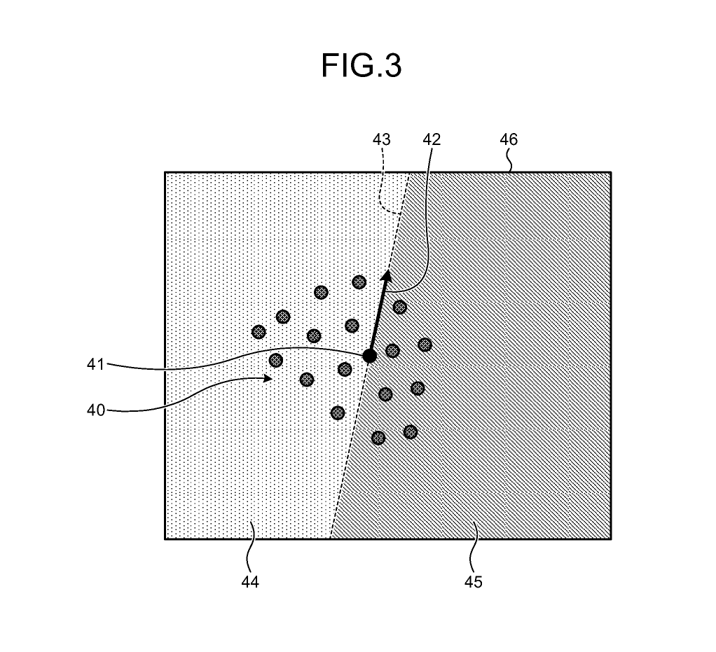

FIG. 3 is a diagram illustrating an example of a method for dividing an image into regions according to the present embodiment. In the example illustrated in FIG. 3, the determination unit 24 calculates a center-of-gravity point 41 from candidate points 40 on an image 46 and performs the principal component analysis to calculate a principal component direction 42. The determination unit 24 considers a line 43 extending in the principal component direction 42 to divide the image 46 into two regions 44 and 45. The determination unit 24 uses candidate points 40 belonging to the region 44 containing a larger number of candidate points 40 to determine the measurement situation.

The determination unit 24 calculates combinations of respective projection points xp belonging to a set Proj of projection points and candidate points xc belonging to the region containing the largest number of candidate points such that the distance between a projection point xp and a candidate point xc is the shortest, and calculates combinations of respective candidate points xc belonging to the region and projection points xp belonging to the set Proj such that the distance between a candidate point xc and a projection point xp is the shortest. The determination unit 24 thus obtains a set P of combinations.

The determination unit 24 calculates a distance D for each combination. If the distance D is equal to or smaller than a certain value γ1, the determination unit 24 updates a measured flag F of a candidate point of each combination to 1. Although, in the present embodiment, the certain value γ1 is assumed to be 1% of the height or the width of the image, the embodiment is not limited to this. The measured flag F is a flag indicating whether a three-dimensional point X_T corresponding to a candidate point (reprojection point) has successfully been measured. When the measured flag F is 1, the three-dimensional point X_T has successfully been measured. When it is 0, the three-dimensional point X_T has not been successfully measured. The initial value of the measured flag F is 0. The value of the measured flag F is inherited even when the set T of reprojection points is updated by the second calculator 22 and when the set TC of candidate points is updated.

The determination unit 24 determines that, when the distance D of each combination is equal to or smaller than the certain value γ1, the combination belongs to a first category, when the distance D is larger than the certain value γ1 and equal to or smaller than a certain value γ2, the combination belongs to a second category, and when the distance D is larger than the certain value γ2, the combination belongs to a third category. Although the certain value γ2 may be determined, for example, to be 5% of the height or the width of the image, the embodiment is not limited to this. The number of categories is not limited to three, but may be set to any number.

The determination unit 24 determines whether to complete measurement. For example, if the number of elements in the set TC with the measured flag F being 1 is larger than a certain value Φ1, the determination unit 24 determines to complete measurement.

When a determined category indicates continuation of measurement, the informing controller 25 causes the informing unit 26 to inform a measurer of informing information that prompts the measurer to direct the measurement unit 11 to irradiate the object with a light beam in a direction in which the distance decreases. When a determined category indicates completion of measurement, the informing controller 25 causes the informing unit 26 to inform the measurer of informing information indicating that the measurement on an extracted reprojection position is completed. The informing controller 25 causes the informing unit 26 to perform an informing operation by at least one of the following: by outputting images, outputting sounds, outputting light, and by vibration.

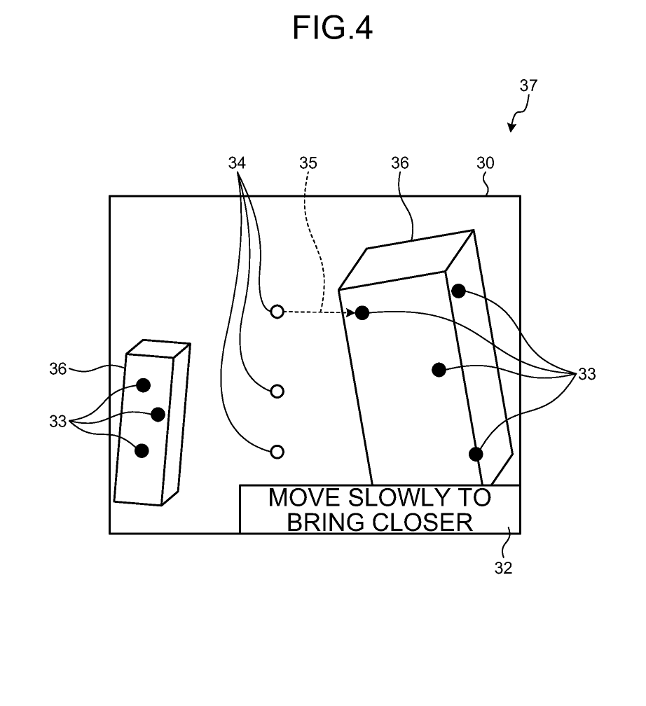

FIG. 4 is a diagram illustrating an example of an informing operation according to the present embodiment. As illustrated in FIG. 4, projection points 34 contained in the set Proj and candidate points 33 contained in the set Cand are discretized into integer values and illustrated on an image 30 containing objects 36, thereby obtaining a measurement instruction image 37. It is preferable that the color of candidate points 33 and that of the projection points 34 are different from each other. It is preferable that a candidate point 33 is illustrated in a different color dependent on whether the value of the corresponding measured flag is 1 or 0, or it is preferable that a candidate point 33 with a measured flag having a value of 1 is not illustrated on the image. The informing controller 25 illustrates an arrow 35 connecting a combination of a projection point 34 and a candidate point 33 on the measurement instruction image 37.

In the example illustrated in FIG. 4, the informing controller 25 displays a different sentence on the measurement instruction image 37 depending on the categories so that the measurer is informed of a category determined by using the distance D. The example of FIG. 4 illustrates a case of the second category (continuation of measurement), and a sentence “move slowly to bring closer” is displayed as a sentence 32. In a case of the third category (continuation of measurement), a sentence “bring closer” is displayed as the sentence 32. In a case of the first category (completion of measurement), a sentence “successfully measured” is displayed as the sentence 32.

The informing controller 25 may inform the measurer of information such that, in the first category, the measurer is informed that the measurement has been successfully performed, and in the second or the third category, the measurer is prompted to move the measurement unit 11 more slowly as the category is closer to the first category. The method for informing the measurer is not limited to displaying the sentence 32. The informing controller 25 may inform the measurer of such information by outputting a beep, instead of displaying a sentence, at regular intervals, and as the category is closer to the first category, the volume of the beep increases or the beep is output at shorter intervals. The informing controller 25 may inform the measurer of the information such that the arrow 35 is illustrated in certain colors depending on the categories. The informing controller 25 may inform the measurer of the information by installing a lighting device such as an LED in advance in the measurement support device to emit light in different colors depending on the categories.

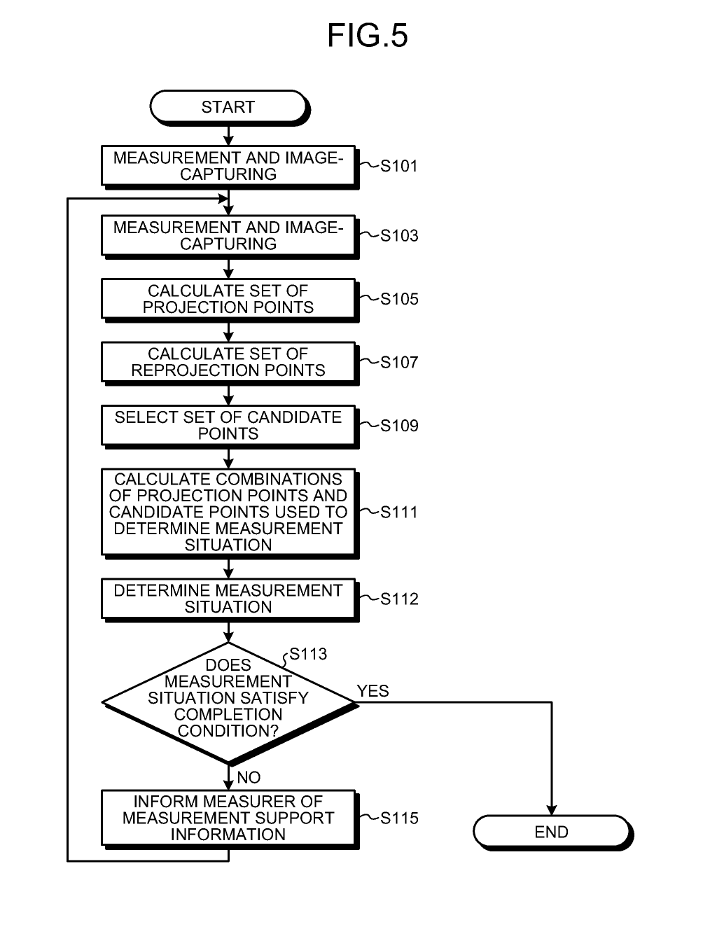

FIG. 5 is a flowchart illustrating an example of the procedure performed by the measurement support device 10 according to the present embodiment.

First, the measurement unit 11 measures an object, and the image-capturing unit 12 captures images of the object (Step S101 and S103).

The first calculator 21 calculates the set Proj of projection points (Step S105).

The second calculator 22 calculates the set T of reprojection points (Step S107).

The selector 23 selects the set TC of candidate points from the set T of reprojection points (Step S109).

The determination unit 24 extracts the set Cand at time t from the set TC of candidate points and calculates combinations of the respective projection points xp belonging to the set Proj of projection points and candidate points xc belonging to the set Cand such that the distance between a projection point xp and a candidate point xc is the shortest, and also calculates combinations of respective candidate points xc belonging to the set Cand and projection points xp belonging to the set Proj such that the distance between a candidate point xc and a projection point xp is the shortest, so that the determination unit 24 calculates the set P of combinations to determine a measurement situation (Step Sill).

The determination unit 24 calculates the distance D for each combination and determines to which category the distance D belongs and a completion condition as the measurement situation (Step S112).

If the completion condition is satisfied, the determination unit 24 ends the measurement (Yes at Step S113).

If the completion condition is not satisfied, the informing controller 25 informs the measurer of information (measurement support information) depending on a category (Step S115), and the processing returns to Step S103.

According to the embodiment described above, the measurement support device informs the measurer of a position of an object acquired from an image captured by the image-capturing unit so that the measurer is prompted to move the measurement unit to irradiate the position with a light beam. This enables the measurer to accurately measure the distance to the position, whereby the measurement support device can accurately calculate the reduced scale of a three-dimensional model of the object, and can contribute to producing an accurate three-dimensional model of the object.

According to the present embodiment, there is no restriction, for example, on an arrangement of a measurement device, thereby easily contributing to producing an accurate three-dimensional model of the object.

Hardware Configuration

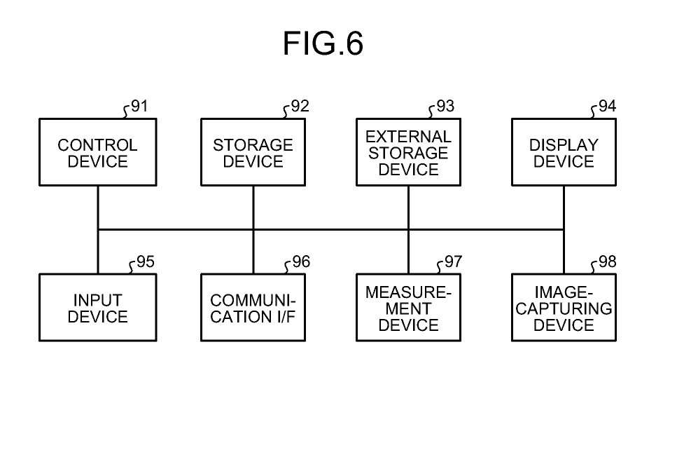

FIG. 6 is a block diagram illustrating an example of a hardware configuration of the measurement support device 10 according to the present embodiment. As illustrated in FIG. 6, the measurement support device 10 according to the present embodiment includes a control device 91 such as a central processing unit (CPU), a storage device 92 such as a read only memory (ROM) and a random access memory (RAM), an external storage device 93 such as a hard disk drive (HDD) and a solid state drive (SSD), a display device 94 such as a display, an input device 95 such as a mouse and a keyboard, a communication I/F 96, a measurement device 97 such as a laser sensor, and an image-capturing device 98 such as a digital camera, and can be implemented by a hardware configuration using a typical computer.

A computer program executed in the measurement support device 10 according to the present embodiment is embedded and provided in a ROM, for example. The computer program executed in the measurement support device 10 according to the present embodiment is recorded and provided, as a computer program product, in a computer-readable recording medium such as a compact disc read only memory (CD-ROM), a compact disc recordable (CD-R), a memory card, a digital versatile disc (DVD), and a flexible disk (FD) as an installable or executable file. The computer program executed in the measurement support device 10 according to the present embodiment may be stored in a computer connected to a network such as the Internet and provided by being downloaded via the network.

The computer program executed in the measurement support device 10 according to the present embodiment has a module configuration that implements the units described above on the computer. As hardware, the control device 91 loads the computer program from the external storage device 93 on the storage device 92 and executes it, thereby implementing the above-described units on the computer.

As described above, the measurement support device according to the present embodiment can contribute to producing an accurate three-dimensional model of an object.

In the embodiment above, for example, the steps of the flowcharts may be performed in a different order, a plurality of steps may be performed simultaneously, or the steps may be performed in a different order for each round of the process, as long as these changes are not inconsistent with the nature of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement support device comprising:
a measurement unit configured to sequentially irradiate an object with a light beam and sequentially measure a direction and a first distance to an irradiated point on the object;
an image-capturing unit configured to sequentially capture images of the object irradiated with the light beam;
a first calculator configured to calculate, when the direction and the first distance to the irradiated point are measured, a projection position on which the irradiated point is projected on each of the images by using the direction, the first distance, and calibration information that is based on calibration performed in advance between the measurement unit and the image-capturing unit;
a second calculator configured to calculate a set of reprojection positions by reprojecting, on each of the images, a three-dimensional position that is based on each of the images sequentially captured;
a determination unit configured to extract, from the set of reprojection positions, a reprojection position on an image containing the projection position calculated from the irradiated point that is measured and captured within a certain time period, calculate a second distance between the reprojection position and the projection position, and determine to which category the second distance belongs; and
an informing controller configured to cause, when the determined category indicates continuation of measurement, an informing unit to inform of informing information that prompts to direct the measurement unit to irradiate the object with the light beam in a direction in which the second distance decreases.

2. The device according to claim 1, wherein the informing controller is configured to, when the determined category indicates completion of measurement, cause the informing unit to inform of informing information indicating that measurement on the extracted reprojection position has been completed.

3. The device according to claim 1, wherein the determination unit is configured to, when the second distance is larger than a threshold, determine that the second distance belongs to a category indicating continuation of measurement, and when the second distance is equal to or smaller than the threshold, determine that the second distance belongs to a category indicating completion of measurement.

4. The device according to claim 1, wherein
the second calculator is configured to reproject, on each of the images, a plurality of three-dimensional positions that are based on each of the images to calculate a plurality of sets of reprojection positions; and
the determination unit is configured to extract, from the sets of reprojection positions, reprojection positions on an image containing the projection position calculated from the irradiated point that is measured and captured within a certain time period, calculate a minimum distance among second distances between the reprojection positions and the projection position, and determine to which category the minimum distance belongs.

5. The device according to claim 4, wherein the determination unit is configured to extract, from the sets of reprojection positions, one or more reprojection positions contained in a region containing a larger number of reprojection positions among the reprojection positions on an image containing the projection position calculated from the irradiated point that is measured and captured within a certain time period.

6. The device according to claim 4, further comprising a selector configured to select, from the sets of reprojection positions, candidate positions that are reprojection positions on which three-dimensional positions with higher measurement accuracy are reprojected to obtain a set of candidate positions, wherein
the determination unit is configured to extract, from the set of candidate positions, a candidate position on an image containing the projection position calculated from the irradiated point that is measured and captured within a certain time period, and calculate a third distance between the candidate position and the projection position.

7. The device according to claim 6, wherein the three-dimensional positions with higher measurement accuracy are three-dimensional positions measured by the image-capturing unit or three-dimensional positions measured by the measurement unit that have higher measurement accuracy than a predetermined value.

8. The device according to claim 1, wherein
the measurement unit is configured to irradiate the object with a plurality of light beams, and measure, for the respective light beams, directions and first distances to irradiated points on the object;
the first calculator is configured to calculate a plurality of projection positions on which the irradiated points are projected on each of the images; and
the determination unit is configured to extract, from the set of reprojection positions, a reprojection position on an image containing the projection positions calculated from the irradiated points that are each measured and captured within a certain time period, calculate a minimum distance among second distances between the respective projection positions and the reprojection position, and determine to which category the minimum distance belongs.

9. The device according to claim 1, wherein the determination unit is configured to extract, from the set of reprojection positions, one or more reprojection positions on an image containing the projection position calculated from the irradiated point that is measured and captured at a same time.

10. The device according to claim 1, wherein the informing controller is configured to cause the informing unit to perform an informing operation by at least one of outputting images, outputting sounds, outputting light, or by vibration.

11. A measurement supporting method comprising:
sequentially irradiating, by a measurement unit, an object with a light beam and sequentially measure a direction and a first distance to an irradiated point on the object;
sequentially capturing images of the object irradiated with the light beam;
calculating, by an image-capturing unit, when the direction and the first distance to the irradiated point are measured, a projection position on which the irradiated point is projected on each of the images by using the direction, the first distance, and calibration information that is based on calibration performed in advance between the measurement unit and the image-capturing unit;
calculating a set of reprojection positions by reprojecting, on each of the images, a three-dimensional position that is based on each of the images sequentially captured;
extracting, from the set of reprojection positions, a reprojection position on an image containing the projection position calculated from the irradiated point that is measured and captured within a certain time period;
calculating a second distance between the reprojection position and the projection position;
determining to which category the second distance belongs; and
causing, when the determined category indicates continuation of measurement, an informing unit to inform of informing information that prompts to direct the measurement unit to irradiate the object with the light beam in a direction in which the second distance decreases.

12. A computer program product comprising a computer-readable medium containing a program executed by a computer, the program causing the computer to execute:
sequentially irradiating, by a measurement unit, an object with a light beam and sequentially measure a direction and a first distance to an irradiated point on the object;
sequentially capturing images of the object irradiated with the light beam;
calculating, by an image-capturing unit, when the direction and the first distance to the irradiated point are measured, a projection position on which the irradiated point is projected on each of the images by using the direction, the first distance, and calibration information that is based on calibration performed in advance between the measurement unit and the image-capturing unit;
calculating a set of reprojection positions by reprojecting, on each of the images, a three-dimensional position that is based on each of the images sequentially captured;
extracting, from the set of reprojection positions, a reprojection position on an image containing the projection position calculated from the irradiated point that is measured and captured within a certain time period;
calculating a second distance between the reprojection position and the projection position;
determining to which category the second distance belongs; and
causing, when the determined category indicates continuation of measurement, an informing unit to inform of informing information that prompts to direct the measurement unit to irradiate the object with the light beam in a direction in which the second distance decreases.
